(19) United States
(12) Patent Application Publication
(10) Pub. No.: US 2026/0253802 A1
(43) Pub. Date: Aug. 27, 2026

(54) ELECTRONIC COMPONENT

(71) Applicant: TDK Corporation, Tokyo (JP)

(72) Inventors: Koki KAGAWA, Tokyo (JP); Daisuke HIMETA, Tokyo (JP); Kota NARUMI, Tokyo (JP)

(73) Assignee: TDK Corporation, Tokyo (JP)

(21) Appl. No.: 19/537,642

(22) Filed: Feb. 12, 2026

(30) Foreign Application Priority Data
Feb. 25, 2025 (JP) 2025-027535

(51) Int. Cl. H01G 4/232; H01G 4/005; H01G 4/248; H01G 4/30

(52) U.S. Cl. CPC H01G 4/2325; H01G 4/005; H01G 4/248; H01G 4/30

(57) ABSTRACT

An electronic component includes an element body including a side surface and an external electrode including a sintered metal layer disposed on the side surface. The sintered metal layer has a shape with a longitudinal direction and a transverse direction, in a cross-section of the sintered metal layer cut with a plane parallel to the side surface at a position 10 μm lower than a maximum height position from the side surface. A ratio of an area of a region of a hypothetical circle that overlaps with the side surface to an area of the side surface is 22% or more, the hypothetical circle circumscribing both ends in the longitudinal direction of the shape.

### CROSS-REFERENCE TO RELATED APPLICATIONS

This application is based upon and claims the benefit of priority from Japanese Patent Application No. 2025-027535, filed on February 25, 2025, the entire contents of which are incorporated herein by reference.

### BACKGROUND

### Field

One aspect of the present disclosure relates to an electronic component.

### Description of the Related Art

Known electronic components include an element body including a side surface, and an external electrode including a sintered metal layer disposed on the side surface (see, for example, Japanese Unexamined Patent Publication No. 2000-260654).

### SUMMARY

An electronic component according to one aspect of the present disclosure includes an element body including a side surface, and an external electrode including a sintered metal layer disposed on the side surface. The sintered metal layer has a shape with a longitudinal direction and a transverse direction, in a cross-section of the sintered metal layer cut with a plane parallel to the side surface at a position 10 μm lower than a maximum height position from the side surface. A ratio of an area of a region of a hypothetical circle that overlaps with the side surface to an area of the side surface is 22% or more, the hypothetical circle circumscribing both ends in the longitudinal direction of the shape.

### BRIEF DESCRIPTION OF THE DRAWINGS

FIG. 1 is a perspective view of a multilayer capacitor according to an example;

FIG. 2 is a diagram illustrating a cross-sectional configuration of the multilayer capacitor according to the example;

FIG. 3 is a diagram illustrating a cross-sectional configuration of the multilayer capacitor according to the example;

FIG. 4 is a perspective view of a modification of the multilayer capacitor according to the example;

FIG. 5 is a diagram illustrating a cross-sectional configuration of a modification of the multilayer capacitor according to the example;

FIG. 6 is a diagram illustrating a cross-sectional configuration of a modification of the multilayer capacitor according to the example;

FIG. 7A and FIG. 7B are diagrams illustrating a configuration of a first electrode layer;

FIG. 8 is a table illustrating test results for each sample; and

FIG. 9 is a table illustrating test results for each sample.

### DETAILED DESCRIPTION

In the following description, with reference to the drawings, the same reference numbers are assigned to the same components or to similar components having the same function, and overlapping description is omitted.

One aspect of the present disclosure provides an electronic component that suppresses the infiltration of moisture into an element body and can suppress the deterioration of electrical characteristics.

Moisture may infiltrate into the element body through the sintered metal layer, as recognized by the present inventor. For example, in the manufacturing process of the electronic component including a plating process, the plating solution may infiltrate into the element body. Moisture that has infiltrated into the element body can deteriorate the electrical characteristics of the electronic component.

The present inventors investigated and researched an electronic component that suppresses the infiltration of moisture into an element body. As a result, the present inventors obtained the following new findings.

In a configuration in which the sintered metal layer has a shape with a longitudinal direction and a transverse direction, in a cross-section of the sintered metal layer cut with a plane parallel to the side surface at a position 10 μm lower than a maximum height position from the side surface, compared to a configuration in which the sintered metal layer has a shape not having a longitudinal direction and a transverse direction in the above-described cross-section, there exist regions where the thickness of the sintered metal layer tends not to decrease, on both sides of and continuous with the region having the above-described shape with the longitudinal and the transverse directions, as viewed from a direction perpendicular to the side surface. Hereinafter, the region having the above-described shape with the longitudinal and the transverse directions is referred to as a first thickness region. As viewed from a direction perpendicular to the side surface, a region including the above-described regions that exist on both sides of the region having the above-described shape with the longitudinal and the transverse directions and in which the thickness of the sintered metal layer tends not to decrease, is referred to as a second thickness region.

The larger the area of the region including not only the first thickness region but also the second thickness region, the more the region where the thickness of the sintered metal layer is large increases on the side surface. In a configuration in which the thickness of the sintered metal layer is large, compared to a configuration in which the thickness of the sintered metal layer is small, moisture tends not to infiltrate into the element body through the sintered metal layer.

The present inventors introduced a hypothetical circle in which the above-described shape with the longitudinal and the transverse directions is inscribed, in order to define the second thickness region. This hypothetical circle circumscribes the above-described shape with a longitudinal direction and a transverse direction at both ends in the longitudinal direction. The above-described hypothetical circle includes not only a perfect circle but also a circle having an oval shape. The oval shape includes, for example, an elliptical shape or a rounded rectangular shape. The region defined by the above-described hypothetical circle includes the entirety of the first thickness region and the second thickness region.

The present inventors further investigated and researched, focusing on the ratio of the area of the region of the above-described hypothetical circle that overlaps with the side surface to the area of the side surface. As a result, the present inventors obtained the following new findings.

In a configuration in which the ratio of the area of the above-described region to the area of the side surface is less than 22%, moisture tends to infiltrate into the element body, and the electrical characteristics tend to deteriorate.

Based on the above-described new findings regarding the ratio of the area of the above-described region to the area of the side surface, the present inventors have conceived the following aspect.

One aspect of the present disclosure relates to an electronic component that includes an element body including a side surface, and an external electrode including a sintered metal layer disposed on the side surface. The sintered metal layer has a shape with a longitudinal direction and a transverse direction, in a cross-section of the sintered metal layer cut with a plane parallel to the side surface at a position 10 μm lower than a maximum height position from the side surface. A ratio of an area of a region of a hypothetical circle that overlaps with the side surface to an area of the side surface is 22% or more, the hypothetical circle circumscribing both ends in the longitudinal direction of the shape.

The above-described one aspect suppresses the infiltration of moisture into the element body, and can suppress the deterioration of electrical characteristics.

In the above-described one aspect, the ratio of the area of the region to the area of the side surface may be 30% or more.

A configuration in which the ratio of the area of the region to the area of the side surface is 30% or more reliably suppresses the infiltration of moisture into the element body, and can further suppress the deterioration of electrical characteristics.

In the above-described one aspect, the ratio of the area of the region to the area of the side surface may be 47% or less.

When comparing a configuration with a large thickness of the sintered metal layer and a configuration with a small thickness of the sintered metal layer for the same chip size, in the configuration with the large thickness of the sintered metal layer, the size of the element body tends to be smaller compared to the configuration with the small thickness of the sintered metal layer. A configuration in which the size of the element body is small tends not to reliably maintain electrical characteristics.

In a configuration in which the ratio of the area of the above-described region to the area of the side surface is 47% or less, the size of the element body tends to be reliably maintained, and a decrease in electrical characteristics is suppressed.

In the above-described one aspect, the side surface may have a rectangular shape with the longitudinal and the transverse directions. An area of the hypothetical circle may be defined by (L₁/2)² × (L_{T}/L_{W}) × π, where L₁ is a length in the longitudinal direction of the shape, L_{W} is a length of the side surface in a width direction of the element body as viewed from a direction perpendicular to the side surface, and L_{T} is a length of the side surface in a height direction of the element body as viewed from a direction perpendicular to the side surface.

A configuration in which the area of the hypothetical circle is defined as described above reliably suppresses the infiltration of moisture into the element body, and can further suppress the deterioration of electrical characteristics.

In the above-described one aspect, a ratio of an area of the shape with the longitudinal and the transverse directions to the area of the side surface may be 5% or more.

A configuration in which the ratio of the area of the shape to the area of the side surface is 5% or more reliably suppresses the infiltration of moisture into the element body, and can further suppress the deterioration of electrical characteristics.

In the above-described one aspect, the ratio of the area of the shape with the longitudinal and the transverse directions to the area of the side surface may be 12% or less.

A configuration in which the ratio of the area of the shape to the area of the side surface is 12% or less tends to reliably maintain the size of the element body, and reliably suppresses the deterioration of electrical characteristics.

In the above-described one aspect, the area of the shape with the longitudinal and the transverse directions may be defined by (L₁/2) × (L₂/2) × π, where L₁ is a length in the longitudinal direction of the shape and L₂ is a length in the transverse direction of the shape.

A configuration in which the area of the shape is defined as described above reliably suppresses the infiltration of moisture into the element body, and can further suppress the deterioration of electrical characteristics.

In the above-described one aspect, the shape with the longitudinal and the transverse directions may include an oval shape.

In a configuration in which the shape includes an oval shape, a ridge can be formed on the sintered metal layer along a major axis direction of the oval shape on the side surface. In a configuration in which the ridge is formed along the major axis direction, the area of the hypothetical circle tends to increase. Therefore, a configuration in which the shape includes an oval shape reliably suppresses the infiltration of moisture into the element body and can further suppress the deterioration of electrical characteristics.

The above-described one aspect may include a plurality of internal electrodes disposed in the element body to oppose each other. An outermost internal electrode located outermost in a direction in which the plurality of internal electrodes are disposed may be located to overlap with the hypothetical circle, as viewed in a direction perpendicular to the side surface.

Moisture tends to infiltrate into the element body from, for example, an exposed end of an internal electrode or an interface between the exposed end and the element body. In a configuration in which the outermost internal electrode is located to overlap with the hypothetical circle as viewed in a direction perpendicular to the side surface, moisture tends not to reach each exposed end of the plurality of internal electrodes or the interface between each exposed end and the element body. Therefore, this configuration reliably suppresses the infiltration of moisture into the element body and can further suppress the deterioration of electrical characteristics.

The above-described one aspect may include a plurality of internal electrodes disposed in the element body to oppose each other. A ratio of a height of the sintered metal layer at a position corresponding to an outermost internal electrode to a height at the maximum height position may be from 30% to 53%, the outermost internal electrode being located outermost in a direction in which the plurality of internal electrodes are disposed.

In a configuration in which the ratio of the height of the sintered metal layer at the position corresponding to the outermost internal electrode to the height at the maximum height position is from 30% to 53%, moisture tends not to reach each exposed end of the plurality of internal electrodes or the interface between each exposed end and the element body. Therefore, this configuration reliably suppresses the infiltration of moisture into the element body and can further suppress the deterioration of electrical characteristics.

In the above-described one aspect, a length of the side surface in a height direction of the element body, as viewed from a direction perpendicular to the side surface, may be smaller than a length of the side surface in a width direction of the element body, as viewed from a direction perpendicular to the side surface.

In a configuration in which the length of the side surface in the height direction of the element body, as viewed from the direction perpendicular to the side surface, is smaller than the length of the side surface in the width direction of the element body, as viewed from the direction perpendicular to the side surface, the electronic component is reduced in height. Therefore, even in a low-profile electronic component, the infiltration of moisture into the element body is suppressed, and the deterioration of electrical characteristics can be suppressed.

In the above-described one aspect, an entirety of the hypothetical circle may overlap with the side surface, as viewed from a direction perpendicular to the side surface.

A configuration in which the entirety of the hypothetical circle overlaps with the side surface as viewed from a direction perpendicular to the side surface reliably suppresses the infiltration of moisture into the element body and can further suppress the deterioration of electrical characteristics.

In the above-described one aspect, the external electrode may include a plating layer located on an outer side of the sintered metal layer.

In a configuration in which the external electrode includes the above-described plating layer, the plating solution may infiltrate into the element body. However, as described above, the above-described one aspect suppresses the infiltration of moisture into the element body and can suppress the deterioration of electrical characteristics. Therefore, even in a configuration in which the external electrode includes the above-described plating layer, the infiltration of the plating solution into the element body is suppressed, and the deterioration of electrical characteristics can be suppressed.

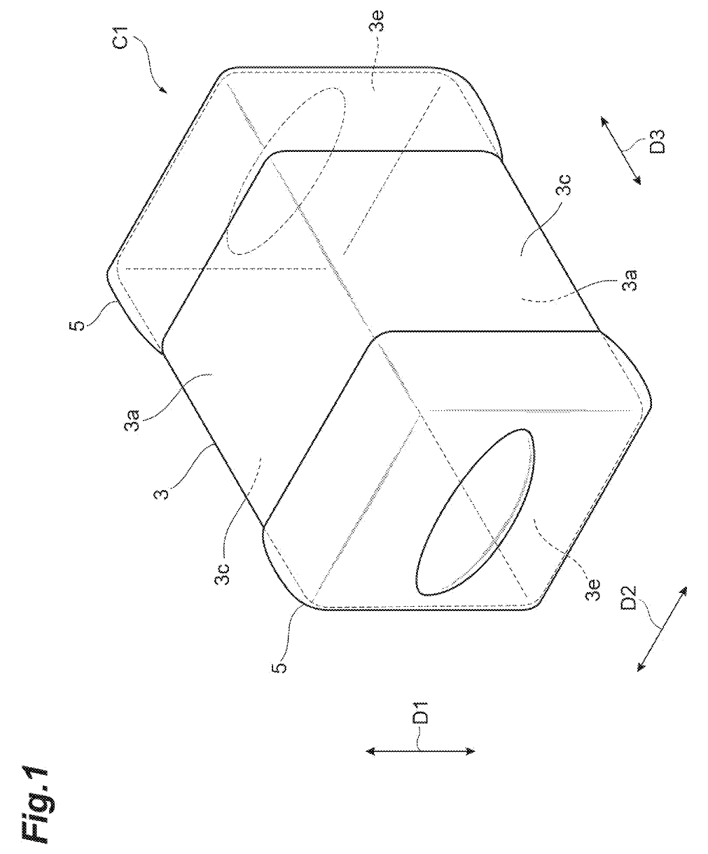

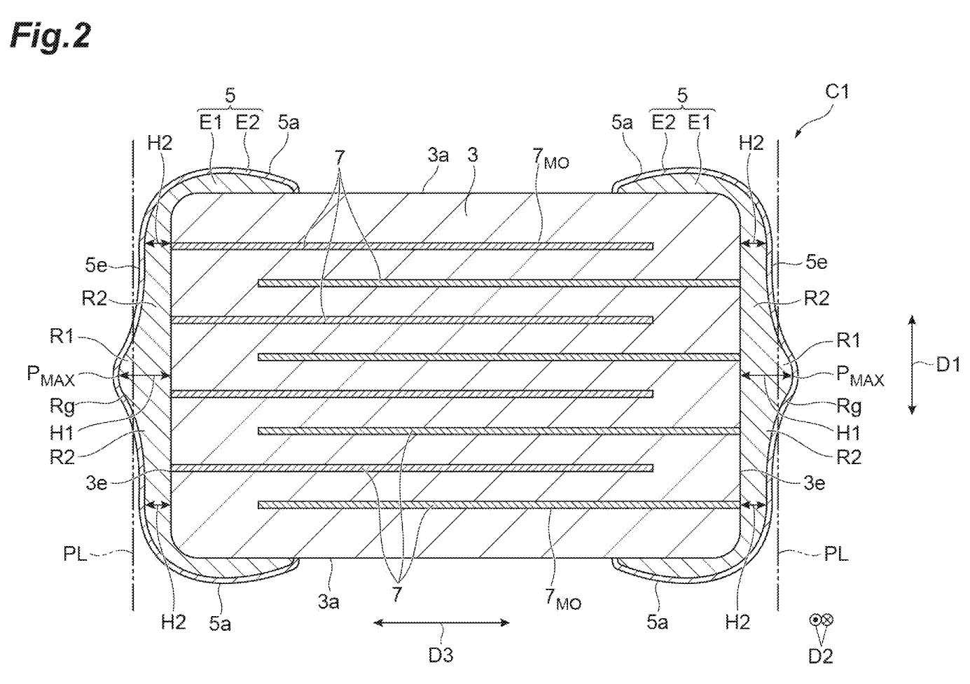

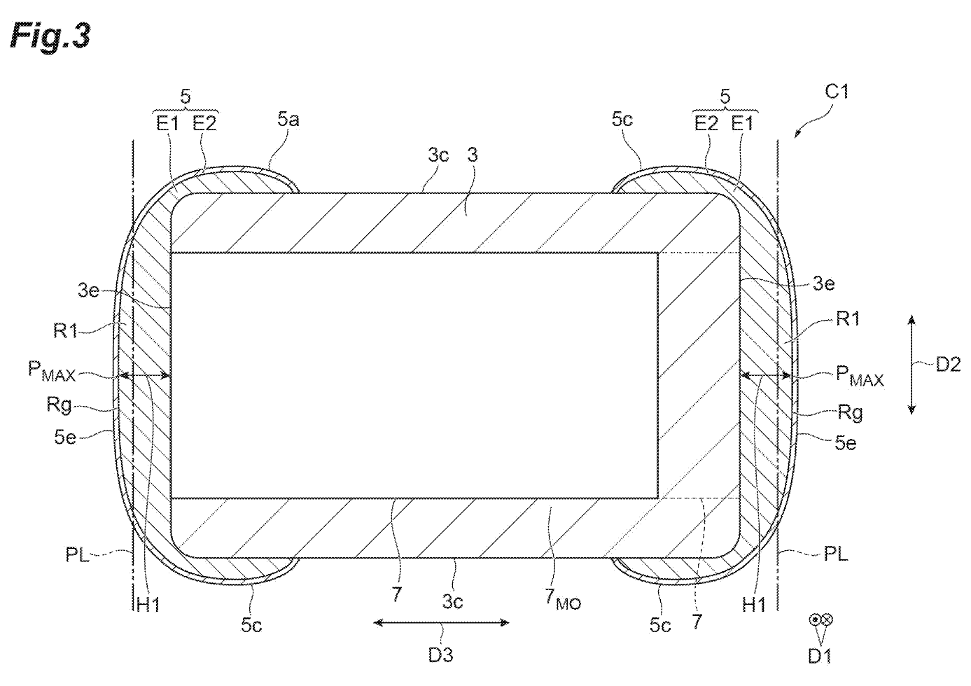

A configuration of a multilayer capacitor C1 according to an example will be described with reference to FIG. 1 to FIG. 3. FIG. 1 is a perspective view of a multilayer capacitor according to an example. FIGS. 2 and 3 are diagrams illustrating a cross-sectional configuration of the multilayer capacitor according to the example.

An electronic component includes, for example, the multilayer capacitor C1.

As illustrated in FIG. 1, the multilayer capacitor C1 includes an element body 3 having a rectangular parallelepiped shape, and a plurality of external electrodes 5. The plurality of external electrodes 5 are disposed on a surface of the element body 3. The plurality of external electrodes 5 are separated from each other. The multilayer capacitor C1 includes, for example, a pair of external electrodes 5. The rectangular parallelepiped shape includes, for example, a rectangular parallelepiped shape in which corners and ridges are chamfered, or a rectangular parallelepiped shape in which corners and ridges are rounded.

The element body 3 includes a pair of side surfaces 3a opposing each other, a pair of side surfaces 3c opposing each other, and a pair of side surfaces 3e opposing each other. Each of the side surfaces 3a, 3c, and 3e has a substantially rectangular shape. The rectangular shape includes, for example, a rectangular shape in which corners are chamfered or a rectangular shape in which corners are rounded.

The pair of side surfaces 3a oppose each other in a direction D1. For example, the direction D1 includes a direction perpendicular to the pair of side surfaces 3a. The pair of side surfaces 3c oppose each other in a direction D2. For example, the direction D2 includes a direction perpendicular to the pair of side surfaces 3c. The pair of side surfaces 3e oppose each other in a direction D3. For example, the direction D3 includes a direction perpendicular to the pair of side surfaces 3e. The direction D1 intersects the direction D2 and intersects the direction D3. The direction D2 intersects the direction D3. For example, the direction D1, the direction D2, and the direction D3 are perpendicular to each other.

The multilayer capacitor C1 is solder-mounted on an electronic device, for example. The electronic device includes, for example, a circuit board or an electronic component. In the multilayer capacitor C1, for example, one of four side surfaces 3a and 3c opposes the electronic device. The one of four side surfaces 3a and 3c is arranged to constitute a mounting surface. The one of four side surfaces 3a and 3c includes the mounting surface.

A length of the element body 3 in the direction D3 is, for example, larger than a length of the element body 3 in the direction D1 and larger than a length of the element body 3 in the direction D2. The length of the element body 3 in the direction D2 and the length of the element body 3 in the direction D1 may be equal to each other. The length of the element body 3 in the direction D2 and the length of the element body 3 in the direction D1 may be different from each other.

The length of the element body 3 in the direction D2 is, for example, from 0.1 to 6.3 mm. The length of the element body 3 in the direction D1 is, for example, from 0.1 to 3.2 mm. The length of the element body 3 in the direction D3 is, for example, from 0.2 to 7.5 mm. In the element body 3, for example, the direction D3 is a longitudinal direction. The length of the element body 3 in the direction D3 is a longitudinal length of the element body 3. The length of the element body 3 in the direction D1 is a height of the element body 3. The length of the element body 3 in the direction D2 is a width of the element body 3.

The pair of side surfaces 3a extend in the direction D2 to couple the pair of side surfaces 3c. The pair of side surfaces 3a extend in the direction D3. The pair of side surfaces 3c extend in the direction D1 to couple the pair of side surfaces 3a. The pair of side surfaces 3c extend in the direction D3. The pair of side surfaces 3e extend in the direction D1 to couple the pair of side surfaces 3a. The pair of side surfaces 3e extend in the direction D2 to couple the pair of side surfaces 3c. The side surface 3e may include a ridge portion at an end coupled to the side surface 3a and at an end coupled to the side surface 3c. This ridge portion may be, for example, rounded to be curved. The side surface 3a may include a ridge portion at an end coupled to the side surface 3c. This ridge portion may be, for example, rounded to be curved. For example, the element body 3 is subjected to what is so-called a round chamfering process.

The element body 3 is configured through laminating a plurality of dielectric layers in the direction D1. The element body 3 includes a plurality of laminated dielectric layers. In the element body 3, a lamination direction of the plurality of dielectric layers coincides with the direction D1. Each dielectric layer includes, for example, a sintered body of a ceramic green sheet containing a dielectric material. Examples of the dielectric material include dielectric ceramics. Examples of the dielectric ceramics include BaTiO₃-based, Ba(Ti, Zr)O₃-based, or (Ba, Ca)TiO₃-based dielectric ceramics. In the actual element body 3, each of the dielectric layers is integrated to such an extent that a boundary between the dielectric layers cannot be visually recognized. In the element body 3, the lamination direction of the plurality of dielectric layers may coincide with the direction D2.

As illustrated in FIGS. 2 and 3, the multilayer capacitor C1 includes a plurality of internal electrodes 7. Each of the internal electrodes 7 is included in an internal conductor disposed in the element body 3. The internal electrodes 7 are made of an electrically conductive material that is commonly used as an internal conductor of a multilayer electronic component. The electrically conductive material includes, for example, a base metal. The electrically conductive material includes, for example, nickel (Ni) or copper (Cu). The internal electrodes 7 are configured as a sintered body of electrically conductive paste containing the electrically conductive material described above. For example, the internal electrodes 7 are made of nickel.

The plurality of internal electrodes 7 are disposed at different positions (layers) in the direction D1. The plurality of internal electrodes 7 are disposed in the element body 3 to oppose each other with an interval in the direction D1. The internal electrodes 7 adjacent in the direction D1 have different polarities from each other. One end of the internal electrode 7 is exposed at a corresponding side surface 3e of the pair of side surfaces 3e. The internal electrode 7 includes one end exposed at the corresponding side surface 3e. The plurality of internal electrodes 7 include an internal electrode 7 exposed at one side surface 3e of the pair of side surfaces 3e, and an internal electrode 7 exposed at the other side surface 3e of the pair of side surfaces 3e. The internal electrodes 7 exposed at the one side surface 3e and the internal electrodes 7 exposed at the other side surface 3e are alternately disposed in the direction D1. The plurality of internal electrodes 7 are disposed in the element body 3 to be distributed in the direction D1. The direction D1 includes a direction in which the plurality of internal electrodes 7 are disposed. The internal electrode 7 is located in a plane substantially parallel to the side surface 3a. A direction in which the internal electrodes 7 oppose each other is substantially perpendicular to a direction parallel to the pair of side surfaces 3a. The plurality of internal electrodes 7 include an outermost internal electrode 7_{MO}. The outermost internal electrode 7_{MO} is located outermost in the direction in which the plurality of internal electrodes 7 are disposed. For example, the outermost internal electrode 7_{MO} is located outermost in the direction D1.

In a configuration in which the lamination direction of the plurality of dielectric layers includes the direction D2, the plurality of internal electrodes 7 are disposed in different positions (layers) in the direction D2. In a configuration in which the lamination direction of the plurality of dielectric layers includes the direction D2, the internal electrodes 7 exposed at the one side surface 3e and the internal electrodes 7 exposed at the other side surface 3e are alternately disposed in the direction D2. The internal electrode 7 is located in a plane substantially parallel to the second pair of side surfaces 3c. The internal electrodes 7 adjacent to each other oppose each other in the direction D2. In a configuration in which the lamination direction of the plurality of dielectric layers includes the direction D2, for example, the outermost internal electrode 7_{MO} is located outermost in the direction D2.

As illustrated in FIGS. 1 to 3, the external electrodes 5 are disposed at both ends of the element body 3 in the direction D3. Each external electrode 5 is disposed on a corresponding side surface 3e of the pair of side surfaces 3e. For example, each external electrode 5 is disposed on the side surface 3e, the pair of side surfaces 3a, and the pair of side surfaces 3c. The external electrode 5 includes a plurality of electrode portions 5a, 5c, and 5e. The electrode portion 5a is located on the side surface 3a. The electrode portion 5c is located on the side surface 3c. The electrode portion 5e is located on the side surface 3e.

The external electrode 5 is formed on five surfaces of the pair of side surfaces 3a, the side surface 3e, and the pair of side surfaces 3c. The electrode portions 5a, 5c, and 5e adjacent to each other are coupled and electrically connected to each other. The external electrode 5 includes a first electrode layer E1 and a second electrode layer E2. For example, each of the electrode portions 5a, 5c, and 5e includes the first electrode layer E1 and the second electrode layer E2. The second electrode layer E2 includes the outermost layer of the external electrode 5.

As illustrated in FIG. 2, the first electrode layer E1 of the electrode portion 5a is disposed on the side surface 3a. The first electrode layer E1 of the electrode portion 5a covers a partial region of the side surface 3a. The first electrode layer E1 of the electrode portion 5a is in contact with the above-described partial region of the side surface 3a. The side surface 3a is exposed from the first electrode layer E1 except for the above-described partial region covered by the first electrode layer E1. The above-described partial region covered by the first electrode layer E1 of the electrode portion 5a is located closer to the side surface 3e.

The second electrode layer E2 of the electrode portion 5a is disposed on the first electrode layer E1. In the electrode portion 5a, the second electrode layer E2 covers the first electrode layer E1. In the electrode portion 5a, the second electrode layer E2 is in contact with the first electrode layer E1. In the electrode portion 5a, the second electrode layer E2 is in direct contact with the first electrode layer E1. In the electrode portion 5a, the second electrode layer E2 is not in contact with the side surface 3a. In the electrode portion 5a, the second electrode layer E2 is spaced apart from the side surface 3a, and is located outside the first electrode layer E1. The second electrode layer E2 of the electrode portion 5a is located on the side surface 3a.

As illustrated in FIG. 3, the first electrode layer E1 of the electrode portion 5c is disposed on the side surface 3c. The first electrode layer E1 of the electrode portion 5c covers a partial region of the side surface 3c. The first electrode layer E1 of the electrode portion 5c is in contact with the above-described partial region of the side surface 3c. The side surface 3c is exposed from the first electrode layer E1 except for the above-described partial region covered by the first electrode layer E1. The above-described partial region covered by the first electrode layer E1 of the electrode portion 5c is located closer to the side surface 3e.

The second electrode layer E2 of the electrode portion 5c is disposed on the first electrode layer E1. In the electrode portion 5c, the second electrode layer E2 covers the first electrode layer E1. In the electrode portion 5c, the second electrode layer E2 is in contact with the first electrode layer E1. In the electrode portion 5c, the second electrode layer E2 is in direct contact with the first electrode layer E1. In the electrode portion 5c, the second electrode layer E2 is not in contact with the side surface 3c. In the electrode portion 5c, the second electrode layer E2 is spaced apart from the side surface 3c, and is located outside the first electrode layer E1. The second electrode layer E2 of the electrode portion 5c is located on the side surface 3c.

The first electrode layer E1 of the electrode portion 5e is disposed on the side surface 3e. The first electrode layer E1 of the electrode portion 5e covers the entirety of the side surface 3e. The first electrode layer E1 of the electrode portion 5e is in contact with the entirety of the side surface 3e. In the electrode portion 5e, the first electrode layer E1 is in direct contact with the side surface 3e.

The second electrode layer E2 of the electrode portion 5e is disposed on the first electrode layer E1. In the electrode portion 5e, the second electrode layer E2 covers the first electrode layer E1. In the electrode portion 5e, the second electrode layer E2 is in direct contact with the first electrode layer E1. In the electrode portion 5e, the second electrode layer E2 indirectly covers the side surface 3e such that the first electrode layer E1 is located between the second electrode layer E2 and the side surface 3e. The second electrode layer E2 of the electrode portion 5e is located on the side surface 3e. In the electrode portion 5e, the second electrode layer E2 is located directly on the first electrode layer E1.

The first electrode layer E1 is formed, for example, through sintering an electrically conductive paste applied onto the surface of the element body 3. The electrically conductive paste is applied onto the partial region of the side surface 3a, the partial region of the side surface 3c, and the side surface 3e. The first electrode layer E1 is formed to cover the side surface 3e and each partial region of the side surfaces 3a and 3c. The first electrode layer E1 is formed through sintering a metal component included in the electrically conductive paste. The metal component included in the electrically conductive paste includes, for example, metal powder. The first electrode layer E1 includes, for example, a sintered metal layer. The first electrode layer E1 includes, for example, a sintered metal layer formed on the element body 3. For example, the first electrode layer E1 includes a sintered metal layer including Cu. The first electrode layer E1 may include a sintered metal layer including Ni. The first electrode layer E1 may include a base metal. The electrically conductive paste may include, for example, particles including Cu or Ni, a glass component, an organic binder, and an organic solvent. The first electrode layers E1 included in the electrode portions 5a, 5c, and 5e are, for example, formed integrally with each other.

The second electrode layer E2 is formed on the first electrode layer E1 through a plating process. The second electrode layer E2 may have a multilayer structure. In a configuration in which the second electrode layer E2 has a multilayer structure, the second electrode layer E2 has, for example, a Ni plating layer and a solder plating layer. The Ni plating layer is formed on the first electrode layer E1. The solder plating layer is formed on the Ni plating layer. The solder plating layer covers the Ni plating layer. The Ni plating layer has better solder leach resistance than the metal included in the first electrode layer E1. The second electrode layer E2 may have an Sn plating layer, a Cu plating layer, or an Au plating layer instead of the Ni plating layer. The solder plating layer includes, for example, an Sn plating layer, an Sn-Ag alloy plating layer, an Sn-Bi alloy plating layer, or an Sn-Cu alloy plating layer. The second electrode layers E2 included in the electrode portions 5a, 5c, and 5e are, for example, formed integrally with each other.

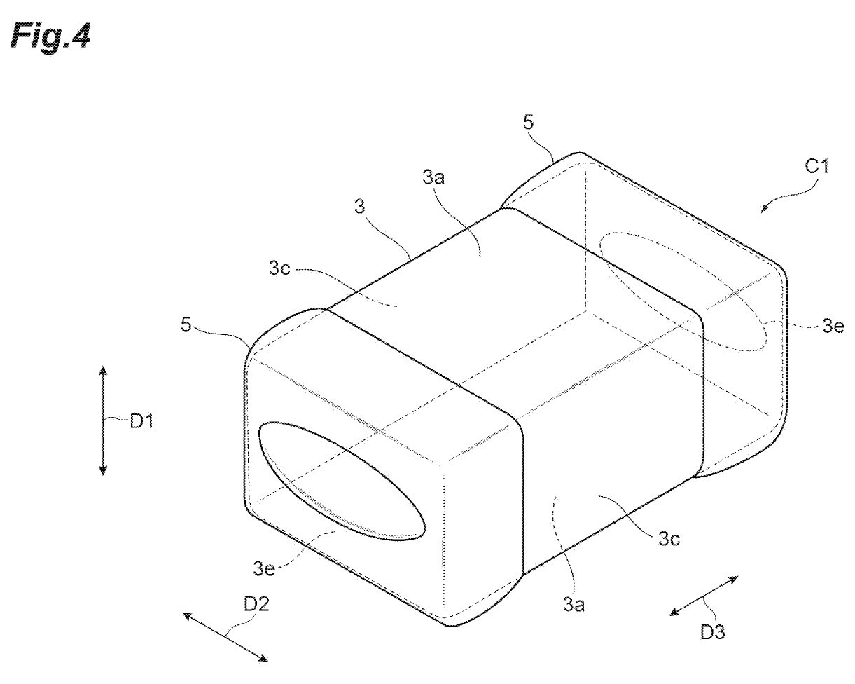

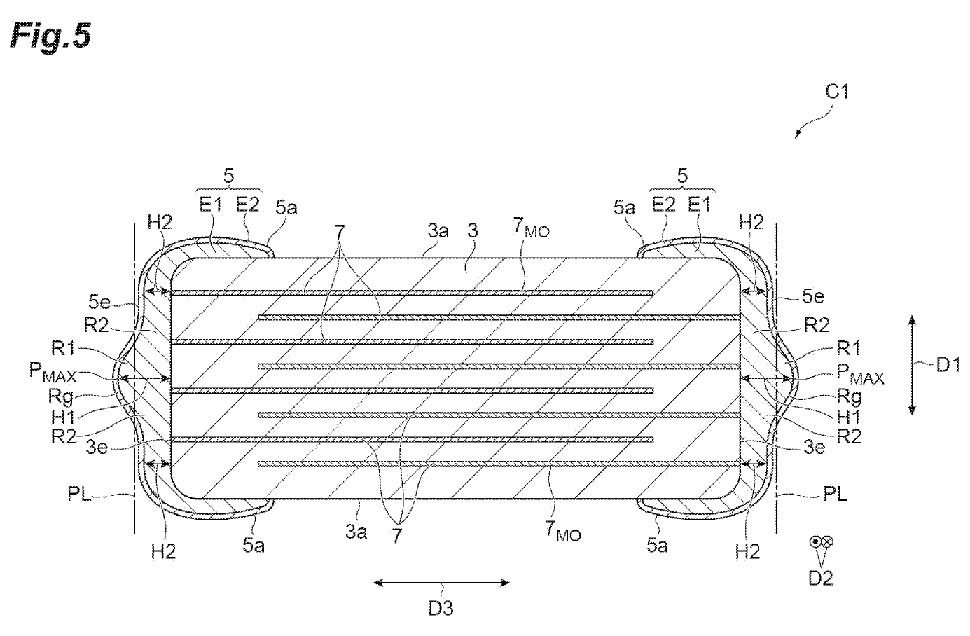

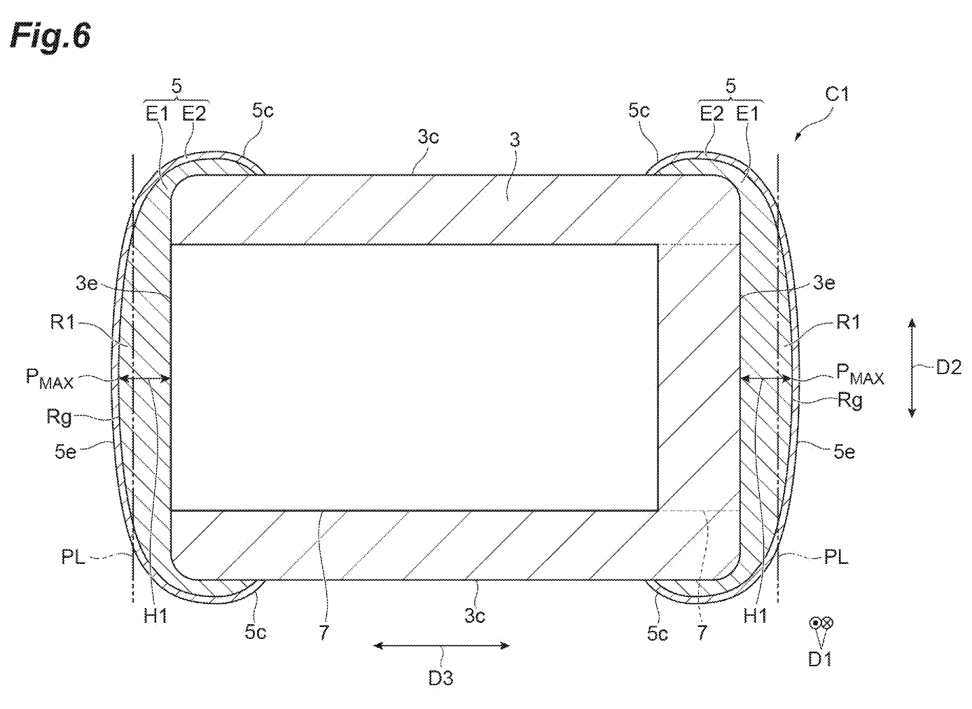

As illustrated in FIGS. 4 to 6, the length of the element body 3 in the direction D1 may be, for example, smaller than the length of the element body 3 in the direction D2. A length of the side surface 3e in a height direction of the element body 3, as viewed from a direction perpendicular to the side surface 3e, may be smaller than a length of the side surface 3e in a width direction of the element body 3, as viewed from a direction perpendicular to the side surface 3e. The length of the element body 3 in the direction D1 is, for example, from 0.5 to 3.0 mm. The length of the element body 3 in the direction D2 is, for example, from 1.0 to 6.0 mm. FIG. 4 is a perspective view of a modification of the multilayer capacitor according to the example. FIGS. 5 and 6 are diagrams illustrating a cross-sectional configuration of a modification of the multilayer capacitor according to the example.

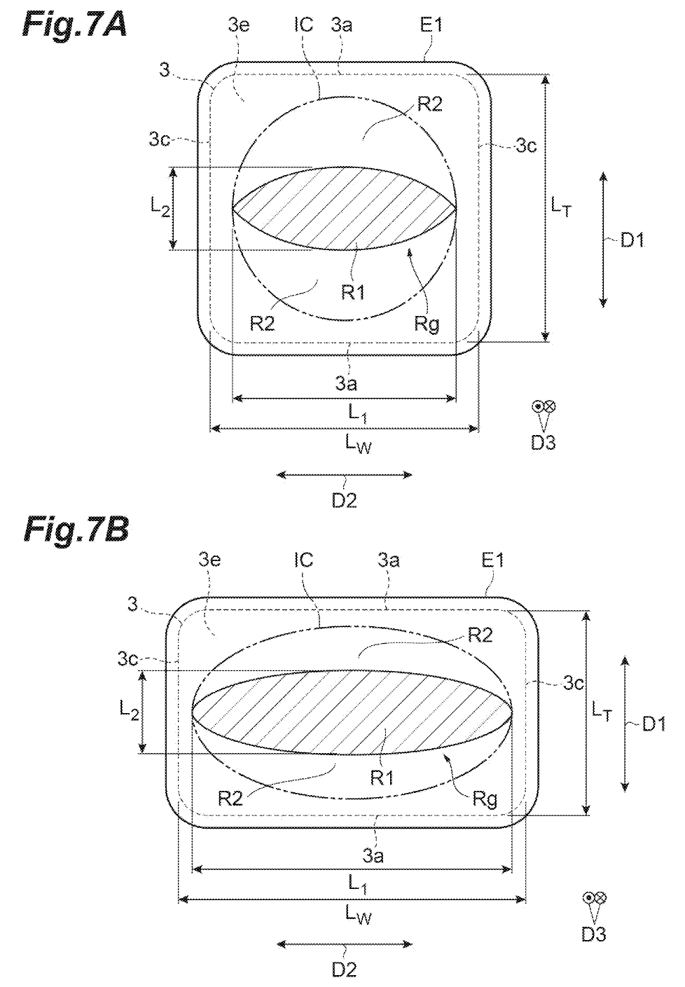

A configuration of the first electrode layer E1 of the electrode portion 5e in the multilayer capacitor C1 will be described with reference to FIGS. 7A and 7B. FIGS. 7A and 7B are diagrams illustrating a configuration of a first electrode layer. FIG. 7A illustrates a configuration of the first electrode layer E1 included in the multilayer capacitor C1 illustrated in FIGS. 1 to 3. FIG. 7B illustrates a configuration of the first electrode layer E1 included in the multilayer capacitor C1 illustrated in FIGS. 4 to 6.

In a cross-section of the first electrode layer E1 of the electrode portion 5e cut with a plane PL parallel to the side surface 3e at a position 10 μm lower than a maximum height position P_{MAX} from the side surface 3e, the first electrode layer E1 includes a region R1 as illustrated in FIG. 7A. The region R1 has a shape with a longitudinal direction and a transverse direction. The first electrode layer E1 has a shape with a longitudinal direction and a transverse direction in the above-described cross-section. The first electrode layer E1 includes regions R2 located on both sides of the region R1 as viewed from a direction perpendicular to the side surface 3e. As illustrated in FIGS. 2 and 3, and FIGS. 5 and 6, the region R2 is continuous with the region R1.

The longitudinal direction of the region R1 includes, for example, the direction D2. The longitudinal direction of the region R1 may include a direction parallel to the side surface 3e and intersecting the direction D2, instead of including the direction D2. For example, the longitudinal direction of the region R1 may include the direction D1.

The region R1 has, for example, an oval shape. The oval shape of the region R1 includes an elliptical shape or a rounded rectangular shape. The oval shape may be any shape that has a substantially oval shape as a whole. For example, even in a configuration in which irregularities are formed on an edge of the region R1, the region R1 may be a shape that has an oval shape as a whole. The region R1 may have a rectangular shape.

As illustrated in FIGS. 2 and 3, and FIGS. 5 and 6, a ridge Rg may be formed on the second electrode layer E2 on the side surface 3e. as viewed from a direction perpendicular to the side surface 3e, the ridge Rg can have a shape corresponding to the shape of the region R1, namely a shape with the longitudinal direction and the transverse direction. The ridge Rg can have a shape with a longitudinal direction and a transverse direction as viewed from a direction perpendicular to the side surface 3e. The ridge Rg may be formed along the longitudinal direction of the region R1. The ridge Rg has, for example, an oval shape as viewed from a direction perpendicular to the side surface 3e. In a configuration in which the region R1 has an oval shape, the ridge Rg may be formed along a major axis direction of the oval shape.

A ratio of an area A_{OR} of a region of a hypothetical circle IC that overlaps with the side surface 3e to an area A₃ₑ of the side surface 3e is 22% or more, the hypothetical circle IC circumscribing both ends in the longitudinal direction of the region R1. The ratio of the area A_{OR} of the hypothetical circle IC to the area A₃ₑ of the side surface 3e may be 30% or more. The ratio of the area A_{OR} of the hypothetical circle IC to the area A₃ₑ of the side surface 3e may be 47% or less.

The area A₃ₑ of the side surface 3e is defined, for example, by an area of a region partitioned on a plane including the side surface 3e by four planes, namely, two planes each including a respective one of the pair of side surfaces 3a and two planes each including a respective one of the pair of side surfaces 3c. The area A₃ₑ of the side surface 3e is defined, for example, by L_{W} × L_{T}. L_{W} is a length in the direction D2 of the above-described region partitioned on the plane including the side surface 3e by the four planes. For example, L_{W} is a length of the side surface 3e in the width direction of the element body 3 as viewed from a direction perpendicular to the side surface 3e. L_{T} is a length in the direction D1 of the above-described region partitioned on the plane including the side surface 3e by the four planes. For example, L_{T} is a length of the side surface 3e in the height direction of the element body 3 as viewed from a direction perpendicular to the side surface 3e. The unit of the area A₃ₑ of the side surface 3e is, for example, "mm²".

The area A_{OR} of the hypothetical circle IC is defined by an area of an overlapping region between the hypothetical circle IC and the region partitioned on the plane including the side surface 3e by the above-described four planes, as viewed in a direction perpendicular to the side surface 3e. The unit of the area A_{OR} is, for example, "mm²".

As illustrated in FIGS. 7A and 7B, the entirety of the hypothetical circle IC may overlap with the side surface 3e as viewed from a direction perpendicular to the side surface 3e. The entirety of the hypothetical circle IC may be included in the side surface 3e as viewed from a direction perpendicular to the side surface 3e. In a configuration in which the entirety of the hypothetical circle IC overlaps with the side surface 3e as viewed from a direction perpendicular to the side surface 3e, the area A_{OR} coincides with an area A_{IC} of the hypothetical circle IC. The area A_{IC} of the hypothetical circle IC is defined, for example, by (L₁/2)² × (L_{T}/L_{W}) × π. The unit of the area A_{IC} of the hypothetical circle IC is, for example, "mm²".

L₁ is a length in the longitudinal direction of the region R1. In a configuration in which the region partitioned on the plane including the side surface 3e by the above-described four planes is a square, L_{W} and L_{T} are the same. The unit of L₁, L_{W}, and L_{T} is, for example, "mm".

In a configuration in which the entirety of the hypothetical circle IC overlaps with the side surface 3e as viewed from a direction perpendicular to the side surface 3e, for example, the ratio of the area A_{OR} of the hypothetical circle IC to the area A₃ₑ of the side surface 3e is 22% or more. In this configuration, for example, the ratio of the area A_{OR} of the hypothetical circle IC to the area A₃ₑ of the side surface 3e may be 30% or more, and the ratio of the area A_{OR} of the hypothetical circle IC to the area A₃ₑ of the side surface 3e may be 47% or less.

A ratio of an area A_{R1} of the region R1 to the area A₃ₑ of the side surface 3e may be 5% or more. The ratio of the area A_{R1} of the region R1 to the area A₃ₑ of the side surface 3e may be 12% or less.

The area A_{R1} of the region R1 is defined, for example, by (L₁/2) × (L₂/2) × π. The unit of the area A_{R1} of the region R1 is, for example, "mm²". L₂ is a length in the transverse direction of the region R1.

A ratio of a height H2 of the first electrode layer E1 at a position corresponding to the outermost internal electrode 7_{MO} to a height H1 of the first electrode layer E1 at the maximum height position P_{MAX} may be from 30% to 53%. The height H1 is defined, for example, by a maximum thickness of the first electrode layer E1. The height H2 is defined by a thickness of the first electrode layer E1 at the position corresponding to the outermost internal electrode 7_{MO}.

As illustrated in FIGS. 7A and 7B, the outermost internal electrode 7_{MO} may be located to overlap with the hypothetical circle IC as viewed in a direction perpendicular to the side surface 3e. The outermost internal electrode 7_{MO} may be located to entirely overlap with the hypothetical circle IC as viewed in a direction perpendicular to the side surface 3e.

The present inventors conducted the following test to clarify the relationship among the area A₃ₑ of the side surface 3e, the area A_{OR} of the hypothetical circle IC, and the area A_{R1} of the region R1.

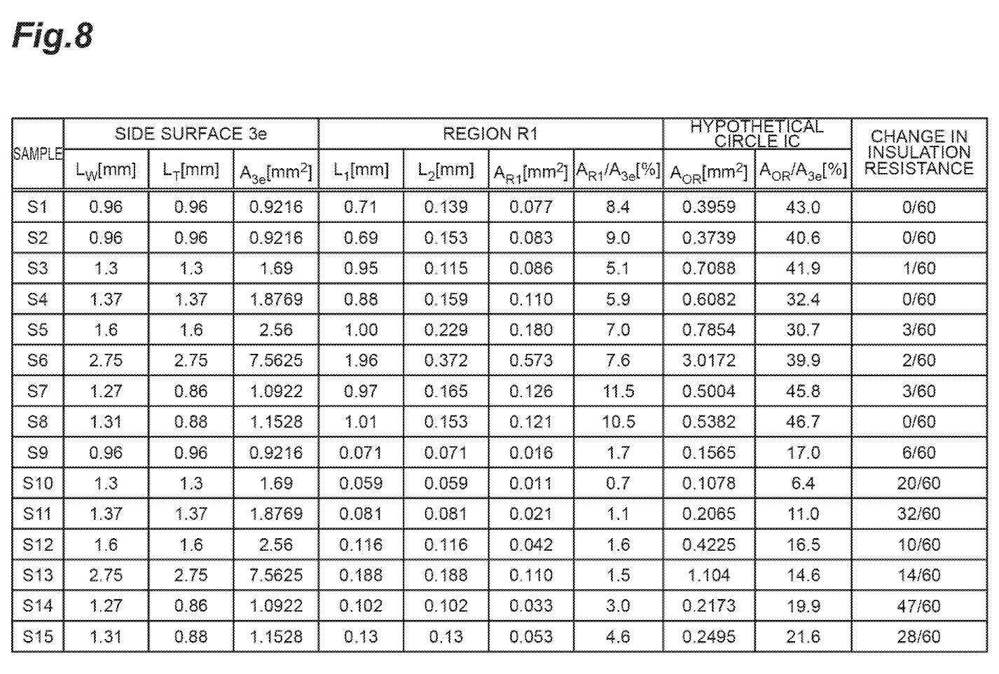

In this test, the present inventors prepared samples S1 to S15 with different areas A₃ₑ of the side surface 3e, areas A_{OR} of the hypothetical circle IC, and areas A_{R1} of the region R1, and confirmed the change in electrical characteristics in each of the samples S1 to S15. In the test, the presence or absence of deterioration of insulation resistance under a high-temperature and high-humidity environment was confirmed as the change in electrical characteristics. The results of the test are presented in FIG. 8. FIG. 8 is a table illustrating test results for each sample.

Each of the samples S1 to S15 is a lot including a plurality of specimens. The specimens of each of the samples S1 to S15 are multilayer capacitors with different areas A₃ₑ of the side surface 3e, areas A_{OR} of the hypothetical circle IC, and areas A_{R1} of the region R1. For each of the samples S1 to S15, 5000 specimens were prepared. For each of the samples S1 to S15, a predetermined number of specimens were selected from the 5000 specimens, and the change in insulation resistance under a high-temperature and high-humidity environment was confirmed for each specimen. In this test, 60 specimens were selected for each of the samples S1 to S15.

In samples S9 to S15, the region R1 has a substantially perfect circle shape. Therefore, in samples S9 to S15, L₁ and L₂ are the same.

In samples S9 to S15, as described above, the region R1 has a substantially perfect circle shape. Therefore, the area A_{OR} of the hypothetical circle IC in samples S9 to S15 is different from the area A_{OR} of the hypothetical circle IC in the multilayer capacitor C1, and is defined as follows.

In sample S1, a reference plane parallel to the side surface 3e is defined. The reference plane is defined such that an area of the first electrode layer E1 in a cross-section obtained by cutting the first electrode layer E1 of the electrode portion 5e with the reference plane is equal to the area A_{OR} of the hypothetical circle IC in sample S1. A distance between the maximum height position P_{MAX} and the reference plane in a direction perpendicular to the side surface 3e is obtained. This distance is defined as a reference distance.

In sample S9, an area of the first electrode layer E1 in a cross-section obtained by cutting the first electrode layer E1 of the electrode portion 5e with a plane parallel to the side surface 3e at a position separated by the reference distance from the maximum height position P_{MAX} is obtained. This area is set as the area A_{OR} of the hypothetical circle IC in sample S9.

Similarly, in samples S10 to S15, a reference plane and a reference distance are respectively defined based on the areas A_{OR} of the hypothetical circles IC in samples S3 to S8, and the area A_{OR} of the hypothetical circle IC in each of samples S10 to S15 is defined.

The procedure of confirming the change in insulation resistance is as follows.

Each specimen is solder-mounted on a substrate. An accelerated test is performed on each specimen solder-mounted on the substrate. The insulation resistance of each specimen before and after the accelerated test is measured. A specimen whose insulation resistance decreases by an order of magnitude or more after the accelerated test is determined to be "defective". In the accelerated test, a rated voltage is continuously applied to each specimen for 24 hours under a constant temperature and humidity environment (temperature: 121°C, relative humidity: 95%, pressure: 2 atm). The insulation resistance after the accelerated test is measured two hours after the accelerated test. When the number of specimens determined to be "defective" out of 60 specimens is three or less, it is determined that the deterioration of insulation resistance is suppressed.

As a result of the above-described test, as illustrated in FIG. 8, it was confirmed that in samples S1 to S8, the change in insulation resistance was suppressed compared to samples S9 to S15.

The present inventors conducted the following test to clarify the relationship between the heights H1 and H2 of the first electrode layer E1.

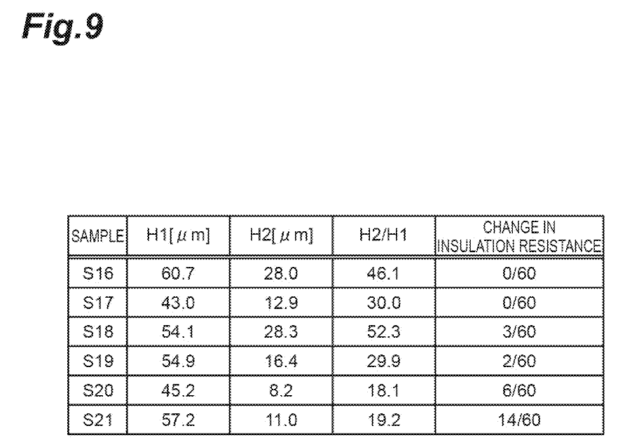

In this test, the present inventors prepared samples S16 to S21 with different heights H1 and H2 of the first electrode layer E1, and confirmed the change in electrical characteristics in each of the samples S16 to S21. In the test, the presence or absence of deterioration of insulation resistance under a high-temperature and high-humidity environment was confirmed as the change in electrical characteristics. The results of the test are presented in FIG. 9. FIG. 9 is a table illustrating test results for each sample.

Each of the samples S16 to S21 is a lot including a plurality of specimens. The specimens of each of the samples S16 to S21 are multilayer capacitors with different heights H1 and H2 of the first electrode layer E1. For each of the samples S16 to S21, 5000 specimens were prepared. For each of the samples S16 to S21, a predetermined number of specimens were selected from the 5000 specimens, and the change in insulation resistance under a high-temperature and high-humidity environment was confirmed for each specimen. In this test, 60 specimens were selected for each of the samples S16 to S21.

Samples S16 to S21 have the following configurations.

Sample S16 has the same configuration as sample S1. Sample S17 has the same configuration as sample S2. Sample S18 has the same configuration as sample S5. Sample S19 has the same configuration as sample S6. Sample S20 has the same configuration as sample S9. Sample S21 has the same configuration as sample S13.

The procedure of confirming the change in insulation resistance is the same as the procedure described above. When the number of specimens determined to be "defective" out of 60 specimens is three or less, it is determined that the deterioration of insulation resistance is suppressed.

As a result of the above-described test, as illustrated in FIG. 9, it was confirmed that in samples S16 to S19, the change in insulation resistance was suppressed compared to samples S20 to S21.

In a configuration in which the first electrode layer E1 includes the region R1, compared to a configuration in which the first electrode layer E1 does not include the region R1, as viewed from a direction perpendicular to the side surface 3e, the regions R2 exist on both sides of the region R1, and are continuous with the region R1. In the region R2, the thickness of the first electrode layer E1 tends not to decrease.

The larger the area of the region including not only the region R1 but also the region R2, the more the region where the thickness of the first electrode layer E1 is large increases on the side surface 3e. In a configuration in which the thickness of the first electrode layer E1 is large, compared to a configuration in which the thickness of the first electrode layer E1 is small, moisture tends not to infiltrate into the element body 3 through the first electrode layer E1.

In a configuration in which the ratio of the area A_{OR} of the hypothetical circle IC to the area A₃ₑ of the side surface 3e is less than 22%, the region where the thickness of the first electrode layer E1 is large tends not to increase. Therefore, in this configuration, moisture tends to infiltrate into the element body 3, and the electrical characteristics tend to deteriorate.

In contrast, in the multilayer capacitor C1, the ratio of the area A_{OR} of the hypothetical circle IC to the area A₃ₑ of the side surface 3e is 22% or more. The multilayer capacitor C1 suppresses the infiltration of moisture into the element body 3, and can suppress the deterioration of electrical characteristics.

A process of forming the first electrode layer E1 including the regions R1 and R2 includes, for example, the following processes.

This process includes: forming a layer on the element body 3, the layer made of an electrically conductive paste and having a predetermined thickness; and applying an electrically conductive paste to a planned region where the region R1 (ridge Rg) is to be formed in the layer that has the predetermined thickness and is located on the side surface 3e. This process includes at least two applications of the electrically conductive paste. The electrically conductive paste typically has viscosity. For example, the electrically conductive paste applied for the second time tends to gradually spread on the layer having the predetermined thickness due to its own viscosity. The region R2 can be formed due to this tendency.

For example, controlling the shape of the above-described planned region controls the shape of the region R1. For example, controlling at least one of the viscosity of the electrically conductive paste or the amount of the electrically conductive paste applied to the above-described planned region controls the size of the region R2.

The ratio of the area A_{OR} of the hypothetical circle IC to the area A₃ₑ of the side surface 3e may be 30% or more.

A configuration in which the ratio of the area A_{OR} of the hypothetical circle IC to the area A₃ₑ of the side surface 3e is 30% or more reliably suppresses the infiltration of moisture into the element body 3, and can further suppress the deterioration of electrical characteristics.

The ratio of the area A_{OR} of the hypothetical circle IC to the area A₃ₑ of the side surface 3e may be 47% or less.

When comparing a configuration with a large thickness of the first electrode layer E1 and a configuration with a small thickness of the first electrode layer E1 for the same chip size, in the configuration with the large thickness of the first electrode layer E1, the size of the element body 3 tends to be smaller compared to the configuration with the small thickness of the first electrode layer E1. A configuration in which the size of the element body 3 is small tends not to reliably maintain electrical characteristics. For example, a multilayer capacitor with a small size of the element body 3 tends to have a small capacitance compared to a multilayer capacitor with a large size of the element body 3.

In a configuration in which the ratio of the area A_{OR} of the hypothetical circle IC to the area A₃ₑ of the side surface 3e is 47% or less, the size of the element body 3 tends to be reliably maintained, and a decrease in electrical characteristics is suppressed.

The area A_{IC} of the hypothetical circle IC may be defined by (L₁/2)² × (L_{T}/L_{W}) × π.

Even in a configuration in which the entirety of the hypothetical circle IC overlaps with the side surface 3e as viewed from a direction perpendicular to the side surface 3e, a configuration in which the area A_{IC} of the hypothetical circle IC is defined as described above reliably suppresses the infiltration of moisture into the element body 3, and can further suppress the deterioration of electrical characteristics.

The ratio of the area A_{R1} of the region R1 to the area A₃ₑ of the side surface 3e may be 5% or more.

A configuration in which the ratio of the area A_{R1} of the region R1 to the area A₃ₑ of the side surface 3e is 5% or more reliably suppresses the infiltration of moisture into the element body 3, and can further suppress the deterioration of electrical characteristics.

The ratio of the area A_{R1} of the region R1 to the area A₃ₑ of the side surface 3e may be 12% or less.

A configuration in which the ratio of the area A_{R1} of the region R1 to the area A₃ₑ of the side surface 3e is 12% or less tends to reliably maintain the size of the element body 3, and reliably suppresses the deterioration of electrical characteristics.

The area A_{R1} of the region R1 may be defined by (L₁/2) × (L₂/2) × π.

A configuration in which the area A_{R1} of the region R1 is defined as described above reliably suppresses the infiltration of moisture into the element body 3, and can further suppress the deterioration of electrical characteristics.

The region R1 may have an oval shape.

In a configuration in which the region R1 has an oval shape, the ridge Rg can be formed on the first electrode layer E1 along a major axis direction of the oval shape on the side surface 3e. In a configuration in which the ridge Rg is formed along the major axis direction, the area A_{OR} of the hypothetical circle IC (the area A_{IC} of the hypothetical circle IC) tends to increase. Therefore, a configuration in which the region R1 has an oval shape reliably suppresses the infiltration of moisture into the element body 3, and can further suppress the deterioration of electrical characteristics.

The outermost internal electrode 7_{MO} may be located to overlap with the hypothetical circle IC, as viewed in a direction perpendicular to the side surface 3e.

Moisture tends to infiltrate into the element body 3 from, for example, an exposed end of the internal electrode 7 or an interface between this exposed end and the element body 3. In a configuration in which the outermost internal electrode 7_{MO} is located to overlap with the hypothetical circle IC as viewed in a direction perpendicular to the side surface 3e, moisture tends not to reach each exposed end of the plurality of internal electrodes 7 or the interface between each exposed end and the element body 3. Therefore, this configuration reliably suppresses the infiltration of moisture into the element body 3, and can further suppress the deterioration of electrical characteristics.

The ratio of the height H2 of the first electrode layer E1 at the position corresponding to the outermost internal electrode 7_{MO} to the height H1 of the first electrode layer E1 at the maximum height position P_{MAX} may be from 30% to 53%.

In a configuration in which the ratio of the height H2 to the height H1 is from 30% to 53%, moisture tends not to reach each exposed end of the plurality of internal electrodes 7 or the interface between each exposed end and the element body 3. Therefore, this configuration reliably suppresses the infiltration of moisture into the element body 3, and can further suppress the deterioration of electrical characteristics.

A length of the side surface 3e in the height direction of the element body 3, as viewed from a direction perpendicular to the side surface 3e, may be smaller than a length of the side surface 3e in the width direction of the element body 3, as viewed from a direction perpendicular to the side surface 3e.

In a configuration in which the length of the side surface 3e in the height direction of the element body 3, as viewed from a direction perpendicular to the side surface 3e, is smaller than the length of the side surface 3e in the width direction of the element body 3, as viewed from a direction perpendicular to the side surface 3e, the multilayer capacitor C1 is reduced in height. Therefore, even in a low-profile multilayer capacitor C1, the infiltration of moisture into the element body 3 is suppressed, and the deterioration of electrical characteristics can be suppressed.

The entirety of the hypothetical circle IC may overlap with the side surface 3e as viewed from a direction perpendicular to the side surface 3e.

In a configuration in which the entirety of the hypothetical circle IC overlaps with the side surface 3e as viewed from a direction perpendicular to the side surface 3e, the region R1 is reliably located on the side surface 3e. The region R1 includes the maximum height position P_{MAX}. Therefore, this configuration reliably suppresses the infiltration of moisture into the element body 3, and can further suppress the deterioration of electrical characteristics.

The external electrode 5 may include the second electrode layer E2 located outside the first electrode layer E1.

In a configuration in which the external electrode 5 includes the second electrode layer E2, the plating solution may infiltrate into the element body 3. However, as described above, the multilayer capacitor C1 suppresses the infiltration of moisture into the element body 3 and can suppress the deterioration of electrical characteristics. Therefore, even in a configuration in which the external electrode 5 includes the second electrode layer E2, the infiltration of the plating solution into the element body 3 is suppressed, and the deterioration of electrical characteristics can be suppressed.

It is to be understood that not all aspects, advantages and features described herein may necessarily be achieved by, or included in, any one particular example. Indeed, having described and illustrated various examples herein, it should be apparent that other examples may be modified in arrangement and detail.

The entirety of the hypothetical circle IC may not overlap with the side surface 3e as viewed from a direction perpendicular to the side surface 3e. The hypothetical circle IC may include a region that does not overlap with the side surface 3e as viewed from a direction perpendicular to the side surface 3e.

However, a configuration in which the entirety of the hypothetical circle IC overlaps with the side surface 3e as viewed from a direction perpendicular to the side surface 3e, as described above, reliably suppresses the infiltration of moisture into the element body 3 and can further suppress the deterioration of electrical characteristics.

In the present example and modification, the electronic component includes the multilayer capacitor. However, the applicable electronic component is not limited to the multilayer capacitor. For example, the applicable electronic component includes a multilayer electronic component such as a multilayer inductor, a multilayer varistor, a multilayer piezoelectric actuator, a multilayer thermistor, a multilayer solid-state battery component, or a multilayer composite component, or electronic components other than the multilayer electronic components.

What is claimed is:

1. An electronic component comprising:
an element body including a side surface; and
an external electrode including a sintered metal layer disposed on the side surface, wherein
the sintered metal layer has a shape with a longitudinal direction and a transverse direction, in a cross-section of the sintered metal layer cut with a plane parallel to the side surface at a position 10 μm lower than a maximum height position from the side surface, and
a ratio of an area of a region of a hypothetical circle that overlaps with the side surface to an area of the side surface is 22% or more, the hypothetical circle circumscribing both ends in the longitudinal direction of the shape.

2. The electronic component according to claim 1, wherein
the ratio of the area of the region to the area of the side surface is 30% or more.

3. The electronic component according to claim 1, wherein
the ratio of the area of the region to the area of the side surface is 47% or less.

4. The electronic component according to claim 1, wherein
the side surface has a rectangular shape, and
an area of the hypothetical circle is defined by (L₁/2)² × (L_{T}/L_{W}) × π, where L₁ is a length in the longitudinal direction of the shape, L_{W} is a length of the side surface in a width direction of the element body as viewed from a direction perpendicular to the side surface, and L_{T} is a length of the side surface in a height direction of the element body as viewed from a direction perpendicular to the side surface.

5. The electronic component according to claim 1, wherein
a ratio of an area of the shape to the area of the side surface is 5% or more.

6. The electronic component according to claim 5, wherein
the ratio of the area of the shape to the area of the side surface is 12% or less.

7. The electronic component according to claim 5, wherein
the area of the shape is defined by (L₁/2) × (L₂/2) × π, where L₁ is a length in the longitudinal direction of the shape and L₂ is a length in the transverse direction of the shape.

8. The electronic component according to claim 1, wherein
the shape includes an oval shape.

9. The electronic component according to claim 1, further comprising a plurality of internal electrodes disposed in the element body to oppose each other, wherein
an outermost internal electrode located outermost in a direction in which the plurality of internal electrodes are disposed is located to overlap with the hypothetical circle, as viewed in a direction perpendicular to the side surface.

10. The electronic component according to claim 1, further comprising a plurality of internal electrodes disposed in the element body to oppose each other, wherein
a ratio of a height of the sintered metal layer at a position corresponding to an outermost internal electrode to a height at the maximum height position is from 30% to 53%, the outermost internal electrode being located outermost in a direction in which the plurality of internal electrodes are disposed.

11. The electronic component according to claim 1, wherein
a length of the side surface in a height direction of the element body, as viewed from a direction perpendicular to the side surface, is smaller than a length of the side surface in a width direction of the element body, as viewed from a direction perpendicular to the side surface.

12. The electronic component according to claim 1, wherein
an entirety of the hypothetical circle overlaps with the side surface, as viewed from a direction perpendicular to the side surface.

13. The electronic component according to claim 1, wherein
the external electrode includes a plating layer located on an outer side of the sintered metal layer.
